(19) United States
(12) Patent Application Publication
(10) Pub. No.: US 2011/0128595 A1
(43) Pub. Date: Jun. 2, 2011

(54) SCANNING SPEED ADJUSTING METHOD AND SCANNING SYSTEM

(76) Inventor: Cheng-Yuan Chen, Taoyuan Hsien (TW)

(21) Appl. No.: 12/829,892

(22) Filed: Jul. 2, 2010

(30) Foreign Application Priority Data
Dec. 2, 2009 (TW) 098141220

(51) Int. Cl. H04N 1/04

(52) U.S. Cl. 358/486

(57) ABSTRACT

A scanning speed adjusting method is used in a scanning system including a scanning module and a controller. Firstly, a document is scanned by the scanning module, thereby generating an image data. Then, the image data is received by the controller, and transmitted to an output device. An input speed of receiving the image data from the scanning module and an output speed of transmitting the image data to the output device are detected by the controller. If the input speed and the output speed are different, a scanning speed of the scanning module is adaptively adjusted according to a difference between the input speed and the output speed.

### CLAIM OF PRIORITY

This application claims priority to Taiwanese Patent Application No. 098141220 filed on Dec. 2, 2009.

### FIELD OF THE INVENTION

The present invention relates to a scanning speed adjusting method, and more particularly to a scanning speed adjusting method for use in a scanning system.

### BACKGROUND OF THE INVENTION

A multifunction peripheral is widely used to generate image data corresponding to the contents of the original document. These image data are usually transmitted to and stored in the host side through an input/output (I/O) cable. For example, the image data are transmitted from the multifunction peripheral side to a computer side. The transmission speed of the image data is related to the communication protocol between the multifunction peripheral side and the host side. Ideally, the speed of generating the image data to be transmitted to the host side is the same as the speed of receiving the image data by the host side. In such circumstance, the scanning system does not need a memory buffer to accumulate and store the to-be-sent image data. In practice, the speed of generating the image data and the speed of receiving the image data by the host side are usually different. If the speed of receiving the image data by the host side is faster than the speed of generating the image data, the multifunction peripheral may generate the image data at a faster speed without the problem of causing data loss. On the other hand, if the speed of generating the image data is faster than the speed of receiving the image data by the host side, the scanning efficiency is impaired.

In addition to optical resolution, the scanning speed and the transmission speed are important factors influencing the scanning functions of the multifunction peripheral. As known, the scanning speed indicates the speed of generating the scanning data. Generally, the scanning speed is equal to the moving speed of the image reader of the scanner or the feeding speed of the automatic document feeder. The transmission speed is in reverse proportion to the time period for returning the image data to the host. If the transmission speed is slower than the scanning speed, the image data may be accumulated in the memory buffer of the scanner. The image data accumulated in the memory buffer possibly overflow even if a portion of the original document has been scanned. For avoiding the data loss problem resulted from overflow of the memory buffer, the scan driving unit (e.g. a motor) of the multifunction peripheral is usually disabled to stop the scanning operation. After the data accumulated in the memory buffer have been completely sent out or the memory buffer has space for storing additional data, the scanning operation of the scan driving unit will be performed again in order to process the remaindering data. In other words, the scanning operation is alternately stopped and performed until the image data have been completely processed.

Since the scanning operation is alternately stopped and performed, the image scanned by the multifunction peripheral is readily suffered from dithering because vibration is generated when the scanning operation is stopped or performed or a mechanical gap is existed. Under this circumstance, the imaging quality is deteriorated.

For solving the above drawbacks, another method is disclosed. After the motor is disabled and then activated again, the scanning operation is performed at a slower scanning speed. Since the scanning operation is alternately stopped and performed, the image scanned by the multifunction peripheral is also suffered from dithering because vibration is possibly generated when the canning operation is stopped or performed. In other words, the imaging quality is deteriorated. Moreover, since the scanning speed is reduced, the scanning efficiency is usually insufficient.

Therefore, there is a need of providing a scanning speed adjusting method for use in a scanning system, thereby obviating the drawbacks encountered from the prior art.

### SUMMARY OF THE INVENTION

It is an object of the present invention to provide a scanning speed adjusting method for use in a scanning system so as to enhance the scanning quality.

In accordance with an aspect of the present invention, there is provided a scanning speed adjusting method for use in a scanning system of an electronic device. The scanning system includes a scanning module and a controller. Firstly, a document is scanned by the scanning module, thereby generating an image data. Then, the image data is received by the controller, and transmitted to an output device. An input speed of receiving the image data from the scanning module and an output speed of transmitting the image data to the output device are detected by the controller. If the input speed and the output speed are different, a scanning speed of the scanning module is adaptively adjusted according to a difference between the input speed and the output speed.

In accordance with another aspect of the present invention, there is provided a scanning system of an electronic device. The scanning system includes an output device, an input device and a controller. The input device includes a scanning module and a scan driving unit. The scanning module scans a document to generate an image data. The scan driving unit is connected to the scanning module for driving the scanning module to move at a scanning speed. The controller is connected to the scan driving unit and the output device for controlling operations of the scan driving unit, receiving the image data and transmitting the image data to the output device. An input speed of receiving the image data from the scanning module and an output speed of transmitting the image data to the output device are detected by the controller, and the scanning speed of the scanning module is adaptively adjusted if the input speed and the output speed are different.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a scanning system according to ant embodiment of the present invention;

FIG. 2 schematically illustrates a scanning speed adjusting method according to an embodiment of the present invention; and

FIG. 3 is a flowchart illustrating a scanning speed adjusting method according to another embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

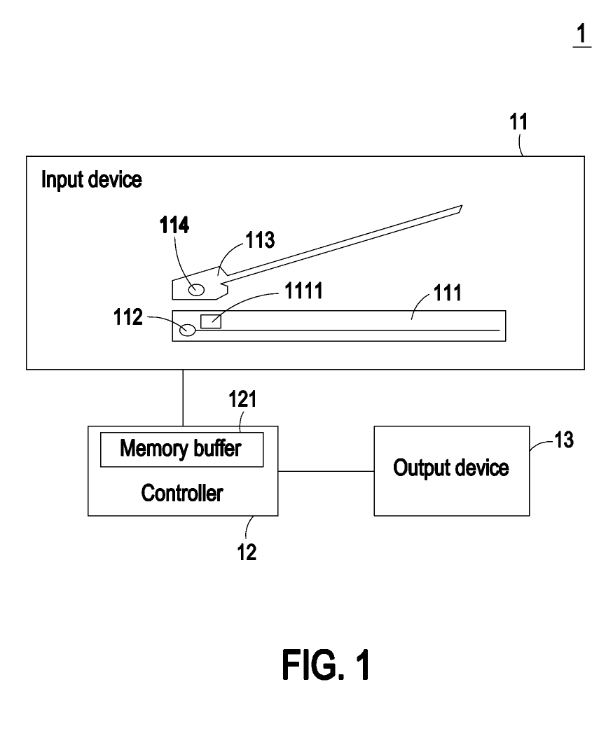

FIG. 1 is a schematic functional block diagram illustrating a scanning system according to ant embodiment of the present invention. The scanning system 1 may be applied to an electronic device such as a multifunction peripheral. As shown in FIG. 1, the scanning system 1 comprises an input device 11, a controller 12 and an output device 13. The controller 12 is electrically connected to the input device 11 and the output device 13. An example of the output device 13 includes a printer engine, a PC, a USB disk or another outputting component or storage component. The input device 11 comprises a scanning module 111, a scan driving unit 112, a sheet transmission mechanism 113 and a sheet transmission driving mechanism 114. An example of the sheet transmission driving mechanism 114 includes but is not limited to a motor. The sheet transmission driving mechanism 114 is used for driving operations of the sheet transmission mechanism 113, so that a document is fed into the internal portion of the input device 11 to be scanned. The scanning module 111 is disposed under the sheet transmission mechanism 113. An example of the scanning module 111 is a flatbed scanner. The scanning module 111 comprises an image reader 1111 such as a contact image sensor (CIS) or a charge coupled device (CCD). An example of the scan driving unit 112 includes but is not limited to a motor. The scan driving unit 112 is used for driving operations of the scanning module 111 and controlling the scanning speed of the scanning module 111, so that the image data of the document could be sensed by the image reader 1111 of the scanning module 111.

Please refer to FIG. 1 again. The controller 12 is electrically connected to the scan driving unit 112 and the sheet transmission driving mechanism 114 of the input device 11, thereby controlling operations of the scan driving unit 112 and the sheet transmission driving mechanism 114. For scanning a document, the scan driving unit 112 and the sheet transmission driving mechanism 114 are controlled by the controller 12 according to the preset scanning type. Meanwhile, the scan driving unit 112 drives the scanning module 111 to scan a document at the scanning speed corresponding to scanning type, thereby generating an image data. The image data is transmitted to the controller 12 and temporarily stored in a memory buffer 121. Moreover, the image data may be processed by the controller 12, and the processed image data will be transmitted to the output device 13. At the same time, an input speed of receiving the image data from the scanning module 111 of the input device 11 and an output speed of transmitting the image data to the output device 13 are detected by the controller 12. If the input speed and the output speed are different (for example the input speed is greater than the output speed, or the input speed is smaller than the output speed), the scanning speed of the scanning module 111 will be adaptively and dynamically adjusted according to a difference between the input speed and the output speed. In other words, the scan driving unit 112 does not be disabled during the scanning period.

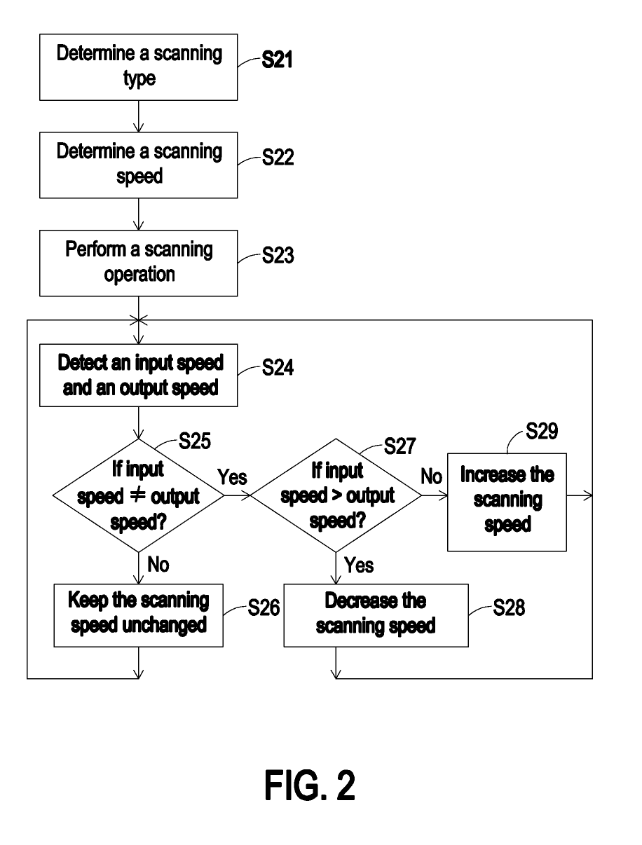

FIG. 2 is a flowchart illustrating a scanning speed adjusting method according to an embodiment of the present invention. First of all, a scanning type (e.g. a black scanning type or a color scanning type) is determined (Step S21). Then, a scanning speed is determined by the controller 12 according to the scanning type (Step S22). The scanning module 111 is driven by the scan driving unit 112 to scan a document at the scanning speed corresponding to scanning type, thereby generating an image data (Step S23). The image data is transmitted to the controller 12 and temporarily stored in the memory buffer 121. The image data may be processed by the controller 12. The processed image data will be transmitted to the output device 13 in a FIFO (first in, first out) manner. At the same time, an input speed of receiving the image data from the scanning module 111 of the input device 11 and an output speed of transmitting the image data to the output device 13 are detected by the controller 12 (Step S24). Then, the controller 12 discriminates whether the input speed and the output speed are different (Step S25). Once the controller 12 discriminates that input speed and the output speed are equal, the scanning speed of the scanning module 111 is kept unchanged (Step S26). Next, the input speed and the output speed are continuously performed (Step S24).

Once the controller 12 discriminates that the input speed and the output speed are different, the controller 12 continuously discriminates whether the input speed is greater than the output speed (Step S27). Once the controller 12 discriminates that the input speed is greater than the output speed, the scanning speed of the scanning module 111 is decreased (Step S28). In this circumstance, the amount of image data transmitted from the scanning module 111 to the memory buffer 121 is reduced in order to avoid overflow of the memory buffer 121. Since the scanning speed is optimized, the scan driving unit 112 does not be disabled during the scanning period. On the other hand, once the controller 12 discriminates that the input speed is smaller than the output speed, the scanning speed of the scanning module 111 is increased (Step S29). In this circumstance, the speed of transmitting the image data from the scanning module 111 to the output device 13 is increased in order to reduce the scanning time and achieve an optimized scanning efficiency.

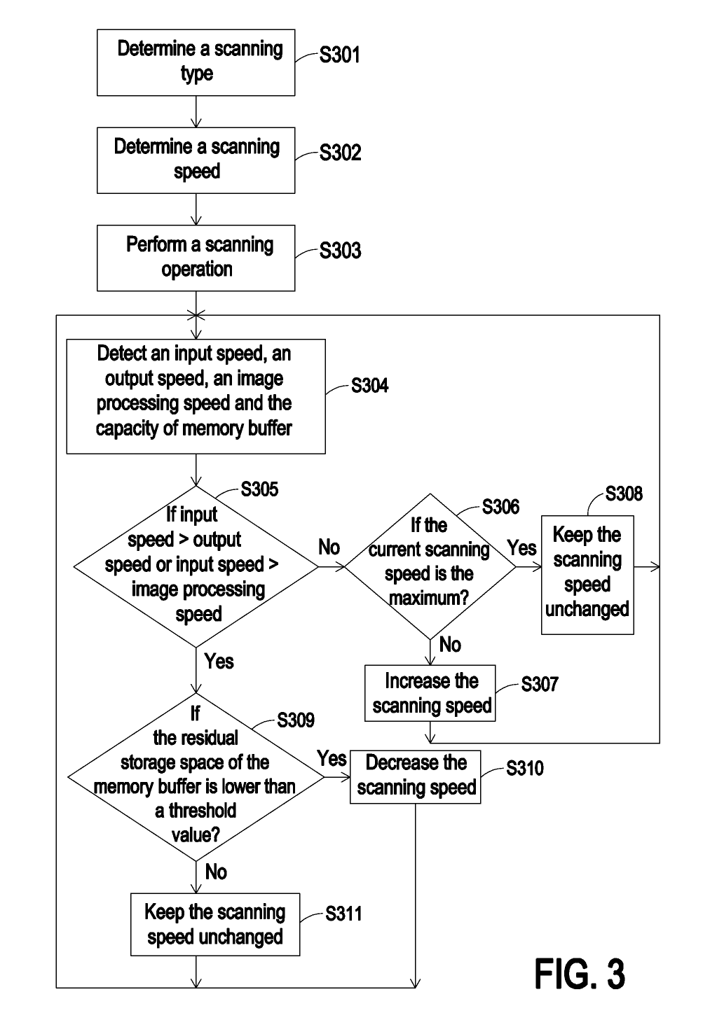

FIG. 3 is a flowchart illustrating a scanning speed adjusting method according to another embodiment of the present invention. First of all, a scanning type (e.g. a black scanning type or a color scanning type) is determined (Step S301). Then, a scanning speed is determined by the controller 12 according to the scanning type (Step S302). The scanning module 111 is driven by the scan driving unit 112 to scan a document at the scanning speed corresponding to scanning type, thereby generating an image data (Step S303). The image data is transmitted to the controller 12 and temporarily stored in the memory buffer 121. The image data may be processed by the controller 12. The processed image data will be transmitted to the output device 13 in a FIFO (first in, first out) manner. At the same time, an input speed of receiving the image data from the scanning module 111 of the input device 11, an output speed of transmitting the image data to the output device 13, an image processing speed of processing the image data and the capacity of memory buffer 121 are detected by the controller 12 (Step S304).

Then, the controller 12 discriminates whether the input speed is greater than the output speed or the input speed is greater than the image processing speed (Step S305). Once the controller 12 discriminates that the input speed is not greater than the output speed or the input speed is not greater than the image processing speed, the controller 12 continuously discriminates whether the current scanning speed is the maximum (Step S306). Once the controller 12 discriminates that the current scanning speed is the maximum, the scanning speed of the scanning module 111 is kept unchanged (Step S308). Once the controller 12 discriminates that the current scanning speed is not the maximum, the scanning speed of the scanning module 111 is increased to the maximum speed (Step S307). That is, when the scanning speed is decreased but the output speed is increased, the scanning speed will be increased to the optimized speed. In this circumstance, the speed of transmitting the image data from the scanning module 111 to the output device 13 is increased in order to reduce the scanning time and achieve an optimized scanning efficiency.

Once the controller 12 discriminates that the input speed is greater than the output speed or the input speed is greater than the image processing speed in Step S305, the controller 12 discriminates whether the residual storage space of the memory buffer 121 is lower than a threshold value (Step S309). For example, the maximum capacity of the memory buffer 121 is 16M, and the residual storage space of the memory buffer 121 is 1M. Once the controller 12 discriminates that the residual storage space of the memory buffer 121 is lower than the threshold value, the scanning speed of the scanning module 111 is decreased (Step S310). In this circumstance, the amount of image data transmitted from the scanning module 111 to the memory buffer 121 is reduced in order to avoid overflow of the of the memory buffer 121. Since the scanning speed is optimized, the scan driving unit 112 does not be disabled during the scanning period.

On the other hand, once the controller 12 discriminates that the residual storage space of the memory buffer 121 is not lower than the threshold value, the scanning speed is kept unchanged (Step S311) because the residual storage space of the memory buffer 121 is sufficient to store the image data.

From the above description, the scanning speed adjusting method of the present invention is capable of adaptively and dynamically adjusting the scanning speed by using the controller to detect the input speed and the output speed. In a case the output speed of the image data is fast, the optimized scanning speed is maintained. Whereas, in a case that the output speed of the image data is slow, the scanning speed is decreased in order to avoid the problems encountered from the prior art. In a case that the scanning speed is decreased but the output speed of the image data is increased, the scanning speed may be increased in order to enhance the transmission efficiency.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A scanning speed adjusting method for use in a scanning system of an electronic device, said scanning system comprising a scanning module and a controller, said scanning speed adjusting method comprising steps of:
(a) scanning a document by said scanning module, thereby generating an image data;
(b) receiving said image data by said controller, and transmitting said image data to an output device; and
(c) allowing said controller to detect an input speed of receiving said image data from said scanning module and an output speed of transmitting said image data to said output device, wherein if said input speed and said output speed are different, a scanning speed of said scanning module is adaptively adjusted according to a difference between said input speed and said output speed.

2. The scanning speed adjusting method according to claim 1 wherein said step (c) further comprising a step (c1) of keeping said scanning speed of said scanning module unchanged if said input speed and said output speed are equal.

3. The scanning speed adjusting method according to claim 2 wherein if said input speed and said output speed detected by said controller are different after said step (c1), said scanning speed adjusting method further comprises a step (c2) of discriminating whether said input speed is greater than said output speed by said controller.

4. The scanning speed adjusting method according to claim 3 wherein when said controller discriminates that said input speed is greater than said output speed in said step (c2), said scanning speed adjusting method further comprises a step (c3) of decreasing said scanning speed of said scanning module.

5. The scanning speed adjusting method according to claim 4 wherein when said controller discriminates that input speed is not greater than said output speed in said step (c2), said scanning speed adjusting method further comprises a step (c4) of increasing said scanning speed of said scanning module.

6. The scanning speed adjusting method according to claim 1 wherein said step (b) further comprises a step (b1) of storing said image data in a memory buffer and processing said image data.

7. The scanning speed adjusting method according to claim 6 wherein said step (c) further comprises a step (c1) of detecting an image processing speed of processing said image data and detecting a capacity of said memory buffer.

8. The scanning speed adjusting method according to claim 7 wherein after said step (c), said scanning speed adjusting method further comprises a step (c2) of discriminating whether said input speed is greater than said output speed or said image processing speed by said controller.

9. The scanning speed adjusting method according to claim 8 wherein when said controller discriminates that said input speed is not greater than said output speed or said image processing speed in said step (c2), said scanning speed adjusting method further comprises a step (c3) of discriminating whether a current scanning speed is the maximum by said controller, wherein when said current scanning speed is the maximum, said current scanning speed is maintained, or when said current scanning speed is not the maximum, said scanning speed of said scanning module is increased to the maximum.

10. The scanning speed adjusting method according to claim 9 wherein when said controller discriminates that said input speed is greater than said output speed or said image processing speed in said step (c2), said scanning speed adjusting method further comprises a step (c4) of discriminating whether residual storage space of said memory buffer is lower than a threshold value by said controller, wherein when said residual storage space of said memory buffer is lower than said threshold value, said scanning speed of said scanning module is decreased, or when said residual storage space of said memory buffer is not lower than said threshold value, said current scanning speed is maintained.

11. The scanning speed adjusting method according to claim 1 wherein said electronic device is a multifunction peripheral.

12. A scanning system of an electronic device, said scanning system comprising:
an output device;
an input device comprising a scanning module and a scan driving unit, wherein said scanning module scans a document to generate an image data, and said scan driving unit is connected to said scanning module for driving said scanning module to move at a scanning speed; and
a controller connected to said scan driving unit and said output device for controlling operations of said scan driving unit, receiving said image data and transmitting said image data to said output device, wherein an input speed of receiving said image data from said scanning module and an output speed of transmitting said image data to said output device are detected by said controller, and said scanning speed of said scanning module is adaptively adjusted if said input speed and said output speed are different.

13. The scanning system according to claim 12 wherein if said input speed and said output speed are equal, said scanning speed of said scanning module is unchanged by said controller.

14. The scanning system according to claim 13 wherein when said controller discriminates that said input speed is greater than said output speed, said scanning speed of said scanning module is decreased by said controller.

15. The scanning system according to claim 14 wherein when said controller discriminates that said input speed is smaller than said output speed, said scanning speed of said scanning module is increased by said controller.

16. The scanning system according to claim 12 wherein said image data received by said controller is temporarily stored in a memory buffer.

17. The scanning system according to claim 12 wherein said electronic device is a multifunction peripheral.
